(19) United States
(12) Patent Application Publication
(10) Pub. No.: US 2023/0051955 A1
(43) Pub. Date: Feb. 16, 2023

(54) System and Method For Regularized Evolutionary Population-Based Training

(71) Applicant: Cognizant Technology Solutions U.S. Corporation, College Station, TX (US)

(72) Inventors: Jason Liang, Fremont, CA (US); Risto Miikkulainen, Stanford, CA (US); Hormoz Shahrzad, Dublin, CA (US); Santiago Gonzalez, Santa Clara, CA (US)

(73) Assignee: Cognizant Technology Solutions U.S. Corporation, College Station, TX (US)

(21) Appl. No.: 17/389,961

(22) Filed: Jul. 30, 2021

(51) Int. Cl. G06N 3/08; G06N 3/04

(52) U.S. Cl. CPC G06N 3/086; G06N 3/04

(57) ABSTRACT

The present invention relates to metalearning of deep neural network (DNN) architectures and hyperparameters. Precisely, the present system and method utilizes Evolutionary Population-Based Based Training (EPBT) that interleaves the training of a DNN's weights with the metalearning of loss functions. They are parameterized using multivariate Taylor expansions that EPBT can directly optimize. Further, EPBT based system and method uses a quality-diversity heuristic called Novelty Pulsation as well as knowledge distillation to prevent overfitting during training. The discovered hyperparameters adapt to the training process and serve to regularize the learning task by discouraging overfitting to the labels. EPBT thus demonstrates a practical instantiation of regularization metalearning based on simultaneous training.

### CROSS-REFERENCE TO RELATED APPLICATIONS

The present application incorporates the following co-owned patent applications and publication herein by reference: U.S. patent application Ser. No. 16/268,463 entitled ENHANCED OPTIMIZATION WITH COMPOSITE OBJECTIVES AND NOVELTY-DIVERSITY SELECTION; U.S. patent application Ser. No. 16/800,208 entitled ENHANCED OPTIMIZATION WITH COMPOSITE OBJECTIVES AND NOVELTY PULSATION; U.S. Pat. No. 17/019,766 entitled LOSS FUNCTION OPTIMIZATION USING TAYLOR SERIES EXPANSION; and Liang et al., Regularized Evolutionary Population-Based Training, GECCO '21: Proceedings of the Genetic and Evolutionary Computation Conference, June 2021, Pages 323-331.

Additionally, one skilled in the art appreciates the scope of the existing art which is assumed to be part of the present disclosure for purposes of supporting various concepts underlying the embodiments described herein. By way of particular example only, prior publications, including academic papers, patents and published patent applications listing one or more of the inventors herein are considered to be within the skill of the art and constitute supporting documentation for the embodiments discussed herein.

### FIELD OF THE EMBODIMENTS

The subject matter described herein, in general, relates to regularizing deep neural network, and, in particular, relates to an improved regularization mechanism of deep neural network through metalearning.

### BACKGROUND

Training modern deep neural networks (DNNs) often requires extensive tuning. Many seminal architectures have been developed through a hand-design process that requires extensive expertise. To make the process easier and more productive, automated methods for metalearning and optimization of DNN hyperparameters and architectures have recently been developed, using techniques such as Bayesian optimization, reinforcement learning, and evolutionary search. At the same time, regularization during training has become an important area of research, as preventing overfitting has been identified as crucial to the generalization capabilities of DNNs.

Thus, metalearning of good DNN hyperparameters and architectures has now become a highly active field of research. One popular approach is to use reinforcement learning to tune a controller that generates the model designs. Another approach is to make the metalearning differentiable to the performance of the DNN, and then learn by gradient descent. Recently, metalearning methods based on evolutionary algorithms (EA) have also gained popularity. These methods can optimize DNNs of arbitrary topology and structure, achieving state-of-the-art results e.g., on large-scale image classification benchmarks, and demonstrating good trade-offs in multiple objectives such as performance and network complexity. Many of these EAs use proven and time-tested heuristics such as mutation, crossover, selection, and elitism to perform black-box optimization on arbitrary complex objectives. Advanced EAs such as CMA-ES have also optimized DNN hyperparameters successfully in high-dimensional search spaces and are competitive with statistical hyperparameter tuning methods such as Bayesian optimization.

However, one challenge shared by every DNN metalearning algorithm is to determine the right amount of training required to evaluate a network architecture and hyperparameter configuration on a benchmark task. Many sub-optimal algorithms simply stop training prematurely, assuming that the partially trained performance is correlated with the true performance. Other methods rely on weight sharing, where many candidate architectures share model layers, thus ensuring that the training time is amortized among all solutions being evaluated. This compels a need to generate a more computationally efficient method for making an empirical choice of hyperparameters to maximize final network performance.

While metalearning seeks to find good DNN architectures, regularization is concerned about preventing DNNs from overfitting during training or optimization. Besides classic penalty- based approaches such as weight decay, there are methods that leverage the structure of DNN layers. One simple but popular approach is dropout, which randomly sets the outputs of a layer to zero. This approach helps prevent overfitting by forcing subsequent layers to adapt to the noise generated by the previous layers. A related technique is batch normalization, which normalizes the outputs of layers and prevents exploding gradients. These approaches work universally on all most all DNN architectures and problem domains and can even be combined.

However, recent focus has been on manipulating training data to help regularize network training. Advanced data augmentation techniques such as cutout, and cutmix purposely create more diverse distributions of the input data to improve generalization and avoid overfitting. Similarly, adversarial examples are another way to regularize by training the network with inputs that are particularly difficult for it to get right. Techniques such as label smoothing and knowledge distillation/self-distillation soften the training targets to ensure more properly behaved gradients, resulting in better generalization.

Along the same lines, one promising such approach is evolution of loss functions to achieve better regularization through modification of gradients. DNNs are trained through the backpropagation of gradients that originate from a loss function. Recently, Genetic Loss Optimization (GLO) is proposed as a new type of metalearning, making it possible to automatically discover novel loss functions that can be used to train higher-accuracy neural networks in less time. In GLO, loss functions are represented as trees and optimized through genetic programming. This approach has the advantage of allowing arbitrarily complex loss functions. However, there are pathological functions in this search space with undesirable behaviors, such as discontinuities.

Also, for loss function optimization, instead of optimizing network structure or weights, evolution is used to modify the gradients, making it possible to automatically regularize the learning process. However, as in most prior metalearning methods, evolution serves as an outer loop to network training. Such an approach is computationally prohibitive since fitness evaluations in principle require full training of deep learning networks. Also, the approach cannot adapt loss functions to different stages of learning.

Further, many existing approaches fail to discover loss functions that result in faster training and better convergence than the standard cross-entropy loss. Furthermore, an interesting challenge emerges when both loss functions and the weights are adapted at the same time. The problem becomes inherently deceptive. Configurations that are known allow for fast learning in the beginning but often prove bad for fine tuning at the end of training. Another challenge with the coadaptation is that training is noisy and can overfit to the validation dataset during evolution.

In the background of above existing limitations, there is a need to develop improved regularization method and system that can generate optimum combinations of hyperparameters for training a DNN at a fixed computational budget, effectively optimize loss function, and ensure population diversity within a multi-objective optimization context.

### SUMMARY OF THE EMBODIMENTS

In a first exemplary embodiment, a method for regularizing deep neural network (DNN) is disclosed. The method comprises of: selecting a first set of individuals from an initial population of a generation, wherein the individuals have a corresponding DNN model, hyperparameters and a fitness value associated therewith; generating a second set of individuals from the first set of individuals, wherein the second set consists of one or more new individuals having updated hyperparameters associated therewith; and evaluating the one or more new individuals by training the DNN model to obtain a pool of evaluated individuals with an updated DNN model, the updated hyperparameters and an updated fitness value.

In a second exemplary embodiment, a system for regularizing deep neural network (DNN), is disclosed. The system comprising: a processing arrangement; and a computer-readable medium which includes thereon a set of instructions, wherein the set of instructions is configured to effectuate the processing arrangement to perform procedures comprising: selecting a first set of individuals from an initial population of a generation, wherein the individuals have a corresponding DNN model, hyperparameters and a fitness value associated therewith; generating a second set of individuals from the first set of individuals, wherein the second set consists of one or more new individuals having updated hyperparameters associated therewith; and evaluating the one or more new individuals by training the DNN model to obtain a pool of evaluated individuals with an updated DNN model, the updated hyperparameters and an updated fitness value

### BRIEF DESCRIPTION OF FIGURES

The patent or application file contains at least one drawing executed in color. Copies of this patent or patent application publication with color drawing(s) will be provided by the Office upon request and payment of the necessary fee.1

FIG. 1 illustrates EPBT based system and method, in accordance with a preferred embodiment;

FIGS. 2a and 2b illustrate experimental results of EPBT system as implemented on CIFAR-10 with ResNet-32, in accordance with a preferred embodiment;

FIGS. 3a to 3h demonstrate experimental results on CIFAR-10 with WRN-10-12, WRN-16-8, WRN-22-6, and WRN-28-5, in accordance with one preferred embodiment;

FIGS. 4a to 4b demonstrate experimental results of EPBT system as implemented on SVHN with ResNet-32, in accordance with a preferred embodiment;

FIGS. 5a to 5f illustrates EPBT loss function ancestries for the best candidates across five different runs on CIFAR-10 with ResNet-32, in accordance with a preferred embodiment; and

FIGS. 6a to 6b shows visualization of how the learning rate and momentum of the best individual in the population changes during an EPBT run, in accordance with a preferred embodiment.

### DETAILED DESCRIPTION OF THE EMBODIMENTS

In describing the preferred and alternate embodiments of the present disclosure, specific terminology is employed for the sake of clarity. The disclosure, however, is not intended to be limited to the specific terminology so selected, and it is to be understood that each specific element includes all technical equivalents that operate in a similar manner to accomplish similar functions. The disclosed embodiments are merely exemplary methods of the invention, which may be embodied in various forms.

Generally, the embodiments herein describe an Evolutionary Population-Based Training (EPBT) system and method, an evolutionary algorithm for regularization metalearning evolved from population-based training (PBT). PBT is described in the literature in, for example, Max Jaderberg et al., Population based training of neural networks, arXiv preprint arXiv:1711.09846 (2017), which is incorporated herein by reference in its entirety. In one significant aspect of present disclosure, the system and method develop Evolutionary Population-Based Training (EPBT) as such an approach through four extensions. First, the powerful heuristics from evolutionary black-box optimization are employed to discover promising combinations of hyperparameters for DNN training. In one exemplary embodiment, EPBT uses selection, mutation, and crossover operators adapted from genetic algorithms to find good solutions to parameter optimization problem.

Second, loss function parameterization based on multivariate Taylor expansions called TaylorGLO is combined with EPBT to optimize loss functions more effectively. This parameterization makes it possible to encode many different loss functions compactly and works on a variety of DNN architectures. Importantly, it enables discovery of loss functions that result in faster training and better convergence than the standard cross-entropy loss, in fewer generations.

Third, EPBT utilizes a concept of novelty pulsation, a powerful heuristic that maintains population diversity and helps escape from deceptive traps during optimization. The approach attempts to compensate for the loss of diversity by a selection mechanism that favors novelty pulsation i.e. a systematic method to alternate between novelty selection and local optimization to solve deceptive real-world problem. The method provides turning novelty selection on and off periodically, which allows local search (i.e. exploitation) and novelty search (i.e. exploration) to leverage each other, leading to faster search and better generalization.

Fourth and final, EPBT overcomes challenge of noisy trainings and overfitting during coadaptation of the loss function and the weights, by introducing a new variant of knowledge distillation called Population-Based Distillation (PBD). This method stabilizes training, helps reduce evaluation noise, and thus allows evolution to make more reliable progress. Overall, utilizing a combination of afore-discussed four extensions, Evolutionary Population- Based Training (EPBT) based regularization method and system for DNNs results in faster, more accurate learning.

In accordance with one working embodiment, a Population-Based Training (PBT) optimization algorithm is proposed to optimize a population of models and their hyperparameters to maximize performance. This meta-optimisation process results in effective and automatic tuning of hyperparameters, allowing them to be adaptive throughout training. Briefly, PBT interleaves DNN weight training with the optimization of hyperparameters that are relevant to the training process but also have no particular fixed value (e.g., learning rate). Such online adaptation is crucial in domains where the learning dynamics are non-stationary. Therefore, PBT forms a promising starting point for making loss-function optimization practical as well.

To elaborate on above, PBT uses the weight sharing approach, which is more computationally efficient. It works by alternating between training models in parallel and tuning the model's hyperparameters through an exploit-and-explore strategy. During exploitation, the hyperparameters and weights of well-performing models are duplicated to replace the worst performing ones. During exploration, hyperparameters are randomly perturbed within a constrained search space. Because PBT never retrains models from scratch, it's computational complexity scales only with the population size and not with the total number of hyperparameter configurations searched. Besides tuning training hyperparameters such as the learning rate, PBT can successfully discover data augmentation schedules. Therefore, PBT is selected as a basis for the design of EPBT.

In next working embodiment, the system and method of present disclosure attempts to regularize the network for effective training of DNNs through loss function optimization. Loss functions represent the primary training objective for a neural network. The choice of the loss function can have a significant impact on a network's performance. In one such endeavor, the present system and method optimizes the loss function by making its representation based on multivariate Taylor expansions called TaylorGLO. TaylorGLO parameterization is smoother, has guaranteed continuity and adjustable complexity, and is easier to implement.

Next, novelty selection as a form of novelty search is utilized by the systema and method of present disclosure to augment the original fitness-based selection with novelty, thereby improving the quality-diversity of the population. Novelty is measured through a behavioral description of the individuals, i.e. a phenotypical feature vector that is not related to fitness. An initial set of m elite candidates is first selected based on fitness and sorted according to their novelty score Si, measured as the sum of pairwise distances d of the individual's behavior vector bi to those of all other individuals j in the set:

$${S}_{i} = {\sum }_{j = 1}^{m} d ( {b}_{i} , {b}_{j} ) . \qquad ( 1 )$$

The top k candidates from this set are selected as elites, skipping candidates that represent the same cluster. In principle, fitness-based selection is more greedy than novelty selection and could result in faster convergence. On the other hand, novelty selection explores more diverse candidates, which can help discover better regularization. However, in presently adopted approach of Novelty Pulsation, such exploitation and exploration are both leveraged by switching Novelty Selection on and off for every p generations, resulting in faster convergence and more reliable solutions. Novelty Selection and Pulsation plays an important role in keeping the population diverse enough to avoid deceptive interactions between weight and loss-function adaptation in EPBT based system and method.

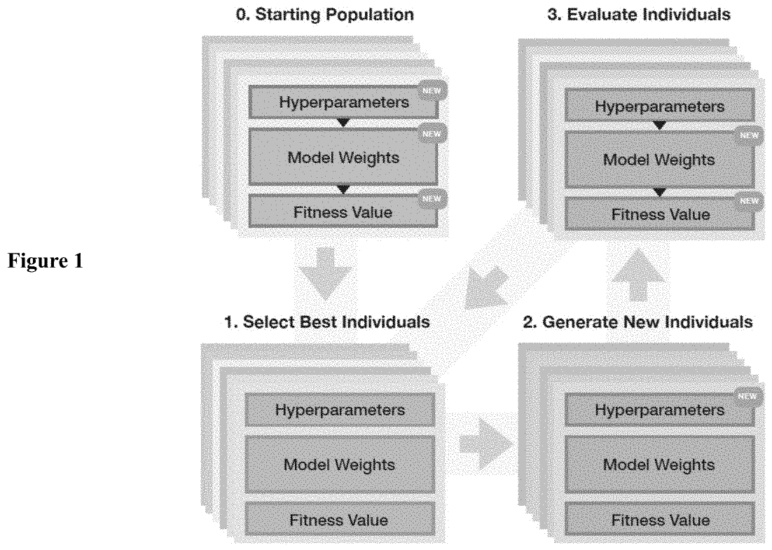

A full functional description of EPBT is provided below. EPBT utilizes genetic operators from black-box optimization to enhance hyperparameter metalearning in PBT, and combines it with loss-function metalearning. The deceptive and overtraining interactions are mitigated through a selection heuristic based on quality-diversity, and through knowledge distillation. FIG. 1 provides a high level description of how EPBT maximizes the fitness of a population of candidate solutions (individuals) over multiple iterations (generations).

More particularly, EPBT begins by randomly initializing individuals, which are composed of hyperparameters, model weights, and fitness values 0. Next, EPBT runs for multiple generations in a three step loop: selection of the best individuals 1; generation of new individuals 2; and evaluation of these individuals 3. In Step 1, promising individuals are selected using a heuristic. In Step 2, new individuals with updated hyperparameters are created, but the weights and fitness are inherited. In Step 3, these individuals are evaluated on a task and have their model weights and fitness (i.e., performance in the task) updated. Thus, EPBT makes it possible to simultaneously train the network and evolve loss function parameterizations.

As a black-box method, EPBT requires no gradient information but only the fitness value of each individual. With EPBT, it is thus possible to apply metalearning to tasks where meta-gradients are not available.

At the beginning of generation g, the population M_{g} consists of individuals M_{gi}. Each M_{gi}={D_{g}, h_{gi}, f_{gi}}, where D_{gi} is a DNN model (both architecture and weights), h_{gi} is a set of hyperparameters, and f_{gi} is a real-valued scalar fitness. In the Step 1 of the generation, f_{gi} is used to select promising individuals \hat{M}_{gi} to form a parent set where [symbol] , where [symbol] ⊂ [symbol] . In the Step 2, [symbol] is used to create a set N_{g}, which contains new individuals N_{gi}. Each of these new individuals inherits D_{gi} from the parent \hat{M}_{gi}, but has updated hyperparameters h_{gi}. The genetic operators used for generating N_{g} will be described in more detail in the later sections. Finally, in Step 3, each N_{gi} is evaluated by training D_{gi} on a task or dataset, thereby creating an updated model \hat{D}_{gi}. The validation performance of \hat{D}_{gi} is used to determine a new fitness value \hat{f}_{gi}. Thus, by the end of generation g, the population pool contains the evaluated individuals \hat{N}_{gi}∈ [symbol] where \hat{N}_{gi}={\hat{D}_{gi}, ĥ_{gi}, \hat{f}_{gi}}. In one preferred embodiment, this process is repeated for multiple generations until the fitness of the best individual in the population converges. Thus, EPBT makes it possible to simultaneously train the network and evolve loss function parameterizations. Now, within the core metalearning evolutionary loop, EPBT contains several other components. They include: (1) A collection of genetic operators specifically chosen for the task of hyperparameter optimization; (2) The Novelty Selection and Pulsation search heuristic that improves population diversity by preserving the most novel elites; (3) A TaylorGLO representation of loss functions with parameters that EPBT can optimize; and (4) Population-Based Distillation method (PBD) that uses the best model in the population to help train other networks. Each of these components will be described in more detail below.

In accordance with one other exemplary embodiment of present disclosure, the entire EPBT process can be parallelized since the evaluation of an individual does not depend on other individuals. In the current implementation of EPBT, fitness evaluations are mapped onto a multi-process pool of workers on a single machine. Each worker has access to a particular GPU of the machine, and if there are multiple GPUs available, every GPU will be assigned to at least one worker. In accordance with one example embodiment, a single worker does not fully utilize the GPU and multiple workers can be trained in parallel without any slowdown.

To begin with, EPBT uses standard evolutionary black-box optimization operators to tune individuals. This details how EPBT is initialized and how these operators are utilized through the three sets of each generation, with a summary as shown in steps below.
Input: max generations n, initial population [symbol] , genetic operators τ, γ, ξ
for g=0 to n . . . I do
   1. Select \hat{M}_{gi}={D_{gi}, h_{gi}, f_{gi}} using τ
   2a. Set h_{gi}=ξ(γ(h_{gi}))
   2b. Set N_{gi}={D_{gi}, h_{gi}}
   3a. Evaluate [symbol] , set N_{gi}={\hat{D}_{gi}, ĥ_{gi}, \hat{f}_{gi}}
   3b. Set [symbol] to top k M_{gi} from [symbol]
   3c. Set [symbol] ₊₁=\hat{N}_{g}∪

[symbol]

Explaining now the above illustration in detail, a population with P individuals is created as M₀. For each M₀ᵢ∈M₀, D₀ᵢ is set to a fixed DNN architecture, and its weights are randomly initialized. Also, each variable in h₀₁ is uniformly sampled from within a fixed range and f₀ᵢ is set to zero. Now in step 1, tournament selection is made whereby using the tournament selection operator τ, t individuals are repeatedly chosen at random from M_{g}. Each time, the individuals are compared and the one with the highest fitness is added to [symbol] . This process is repeated until | [symbol] |=| [symbol] |−k , where k is the number of elites. In one example embodiment, the value t=2 is used.

Following from above, step 2 is a mutation and crossover, wherein in accordance with one exemplary embodiment, for each, \hat{M}_{gi}, a uniform mutation operator γ is applied by introducing multiplicative Gaussian noise independently to each variable in h_{gi}. The mutation operator can randomly and independently reinitialize every variable as well. This approach allows for the exploration of novel combinations of hyperparameters. After mutation, a uniform crossover operator ξ is applied, where each variable in h_{gi} is randomly swapped (50% probability) with the same variable from another individual in [symbol] , resulting in the creation of ĥ_{gi}. D_{gi} is copied from \hat{M}_{gi} and combined with ĥ_{gi} to form the unevaluated individual N_{gi}.

In step 3 of fitness evaluation with elitism, the evaluation process proceeds as described above and results in evaluated individuals [symbol] . After evaluation, EPBT uses an elitism heuristic to preserve progress. In elitism without any Novelty Selection, M_{g} is sorted by f_{gi} and the best k performing individuals [symbol] ⊂ [symbol] are preserved and combined with [symbol] to form M_{g+}1, the population for the next generation. With Novelty Selection, the k individuals are selected based on a combination of fitness and novelty, as discussed above. By default, k may be set to half of the population size. In the same way, that mutation and crossover encourage exploration of a search space, elitism allows for the exploitation of promising regions in the search space. In one preferable embodiment, Novelty Pulsation works by turning Novelty Selection on and off at each pulsation cycle interval p, changing how elite individuals are chosen.

When Novelty Selection is on, M_{g} is first increased to include the most fit m>k candidates, and then filtered down to k most novel elites as described above. In accordance with one working embodiment, the behavior metric used to compute novelty is a binary vector indicating whether the candidate correctly predicts the classes of a randomly chosen N-sized subset of the validation data. This behavior metric encourages evolution to discover models that can perform well generally and not just overfit to a few classes in particular. In one working embodiment, setting m=3/2k, N=400, and p=5 works well and helps protect against premature convergence.

Next working embodiment captures loss function parameterization, wherein to achieve loss function optimization, loss functions are represented by TaylorGLO parameterization. This parameterization is defined as a fixed set of continuous values, in contrast to the original GLO parameterization based on trees. TaylorGLO loss functions have several functional advantages over GLO: they are inherently more stable, smooth, and lack discontinuities. Furthermore, because of their simple and compact representation as a continuous vector, TaylorGLO functions can be easily tuned using black-box methods. In one specific embodiment, a third-order TaylorGLO loss function with parameters θ₀ . . . θ₇, is used, as shown below:

$$ℒ ( \vec{x} , \vec{𝓎} ) = - \frac{1}{n} {\sum }_{i = 1}^{n} [ {θ}_{2} ( {𝓎}_{i} - {θ}_{1} ) + \frac{1}{2} {{θ}_{3} ( {𝓎}_{i} - {θ}_{1} )}^{2} + \frac{1}{6} {{θ}_{4} ( {𝓎}_{i} - {θ}_{1} )}^{3} + {θ}_{5} ( {x}_{i} - {θ}_{0} ) ( {𝓎}_{i} - {θ}_{1} ) + \frac{1}{2} {θ}_{6} ( {x}_{i} - {θ}_{0} ) {( {𝓎}_{i} - {θ}_{1} )}^{2} + \frac{1}{2} {{θ}_{7} ( {x}_{i} - {θ}_{0} )}^{2} ( {𝓎}_{i} - {θ}_{1} ) ] . \qquad ( 2 )$$

Where, \vec{x} is the sample's true label in one-hot form, and \vec{y} is the network's prediction (i.e., scaled logits). The eight parameters (θ₀ . . . θ₇) are stored in h_{gi} and optimized using EPBT.

In one important aspect of present disclosure, population-based distillation (PBD) is further discussed, in continuation to what is explained before. To avoid overfitting during evolution, model evaluation includes a variant of knowledge distillation. The main idea in knowledge distillation is to construct training targets as a linear combination of sample labels and the predictions of a better performing teacher model. A model from the previous epoch can be used as a teacher, resulting in a strong regularizing effect. Thus, in PBD, the loss for an individual's model D_{gi} is computed as

[symbol]

(\vec{x},\vec{y})= [symbol] (α*P_{T}(x̅)+(1−α)*\vec{x},\vec{y})

where Pr (\vec{x}) are the predictions of the best individual in the previous generation and α is a scalar between 0 and 1. The larger the value for α, the greater the influence of the teacher model during training. In one example embodiment, a starts small and is slowly increased over the course of training, to minimize the effect of inaccurate teacher models in the beginning. PBD helps stabilize training, reduce evaluation noise, and regularize against overfitting to the validation dataset, thus allowing evolution to proceed more reliably.

Next, exemplary working embodiment of present EPBT based system and method is discussed to demonstrate effectiveness thereof, wherein loss function optimization is achieved for two image classification datasets: CIFAR-10 and SVHN. To begin with, CIFAR-10 is selected as image classification dataset consisting of 60,000 natural images in ten classes. The dataset is composed of a training set of 50,000 images and a test set of 10,000 images. In order to evaluate individuals in EPBT, a separate validation set of 1,250 images is created by splitting the training set. To control noise during evaluations, the validation dataset is artificially enlarged to 25,000 images through data augmentation. The fitness is calculated by finding the classification accuracy of the trained model on this set. The test accuracies of each individual's model at the end of every generation is also recorded for comparison purposes only.

To understand the improvement brought by EPBT better, two baselines are created. The first baseline is a model trained without EPBT: a 32-layer residual network (ResNet-32) with initialized 0.47 million weights. The model is trained using stochastic gradient descent (SGD) for 200 epochs on all 50,000 training images with a batch size of 128, momentum of 0.9, and cross-entropy loss. A fixed learning rate schedule that starts at 0.1 and decays by a factor of 5 at 60, 120, and 160 epochs is used. Input images are normalized to have unit pixel variance and a mean pixel value of zero before training while data augmentation techniques such as random flips, translations, and cutout are applied during training.

The second baseline is a reimplementation of the original PBT algorithm that is used to optimize DNNs on the CIFAR-10 dataset. The training setup is similar to the first baseline but with learning rate as an evolvable hyperparameter. Unlike EPBT, PBT only makes uses of truncation selection, where the weights and loss parameters from the top 25% of the population are copied over to the bottom 25% every generation, and simple mutation, where the hyperparameters are tuned using a mixture of both random resets and multiplicative perturbations of magnitude 1.2. PBT is run for 25 generations, each with eight epochs of training (for a total of 200 epochs), and with a population size of 40. The learning rate is randomly initialized between 0.1 and 0.0001.

Now, the experiments with EPBT are run using a similar training setup as described above. Like the PBT baselines, EPBT is run for 25 generations of eight epochs each and with a population size of 40. Besides the TaylorGLO loss function parameterization, EPBT optimized the hyperparameters for SGD learning rate schedule and momentum as well. The learning rate schedule is based on the one used by the first baseline but with a tunable scaling and decay factor. This search space allows for the exploration of novel schedules but can rediscover the original schedule if necessary. EPBT is configured similarly as the PBT baseline, but with an elitism size of k=20 and with the initial TaylorGLO parameters sampled uniformly between −10 and 10.

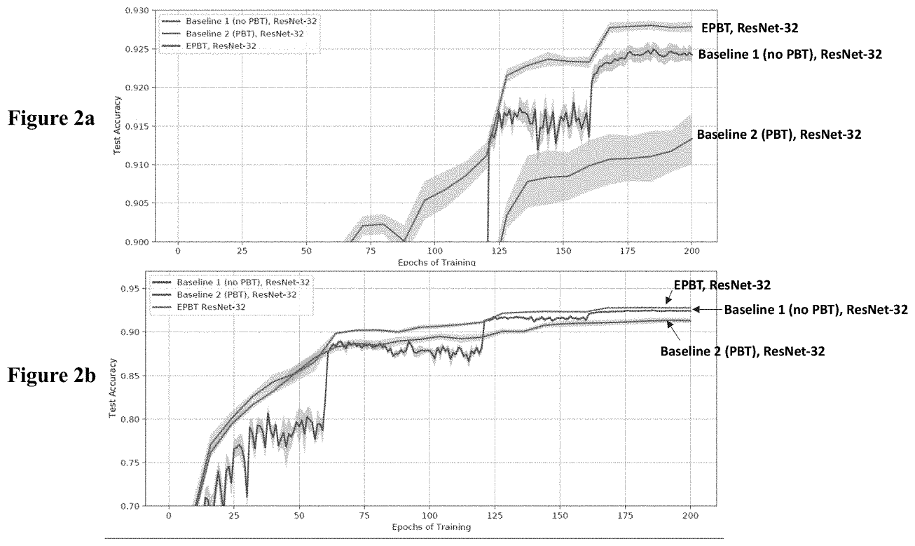

The test accuracies of each baseline and best model in EPBT's population, averaged over five independent runs with standard error, are shown in FIGS. 2a and 2b, wherein each line represents the test classification accuracy (y-axis) of the method over the number of epochs of training (x-axis). All results are averaged over five runs with error bars shown. FIG. 2a is a zoomed-in version of FIG. 2b. EPBT converges rapidly to the highest test accuracy and outperforms all other baselines. Baseline 2 (PBT) results in the worst performance, followed by the Baseline 1, which does not use a population at all. The poor performance of PBT compared to EPBT is probably be due to learning rate being a deceptive trap; a high learning rate helps training initially but may hurt performance in the end. EPBT can escape such traps with the help of Novelty Selection and Pulsation and its more advanced learning rate schedule setup.

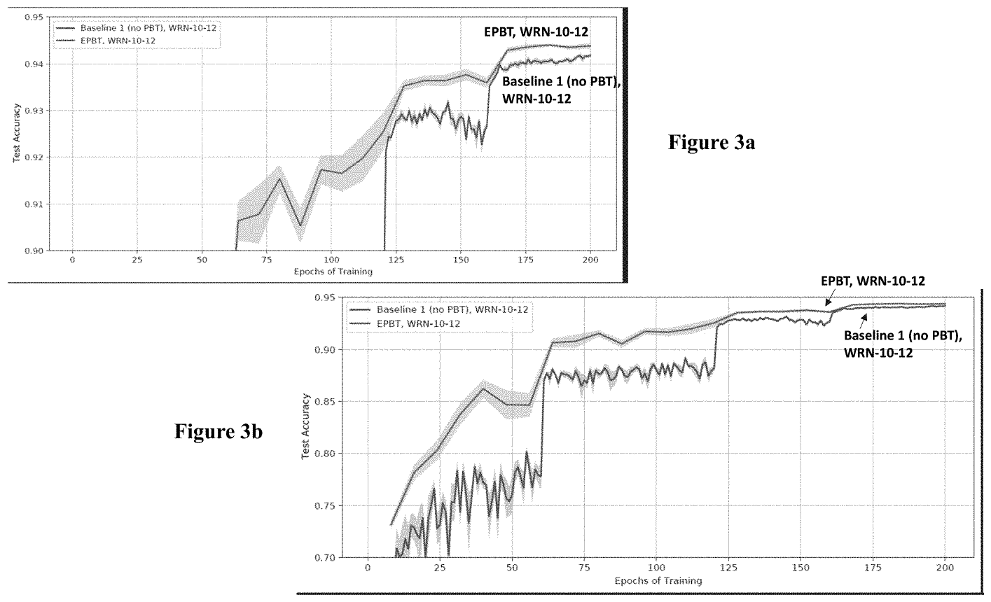

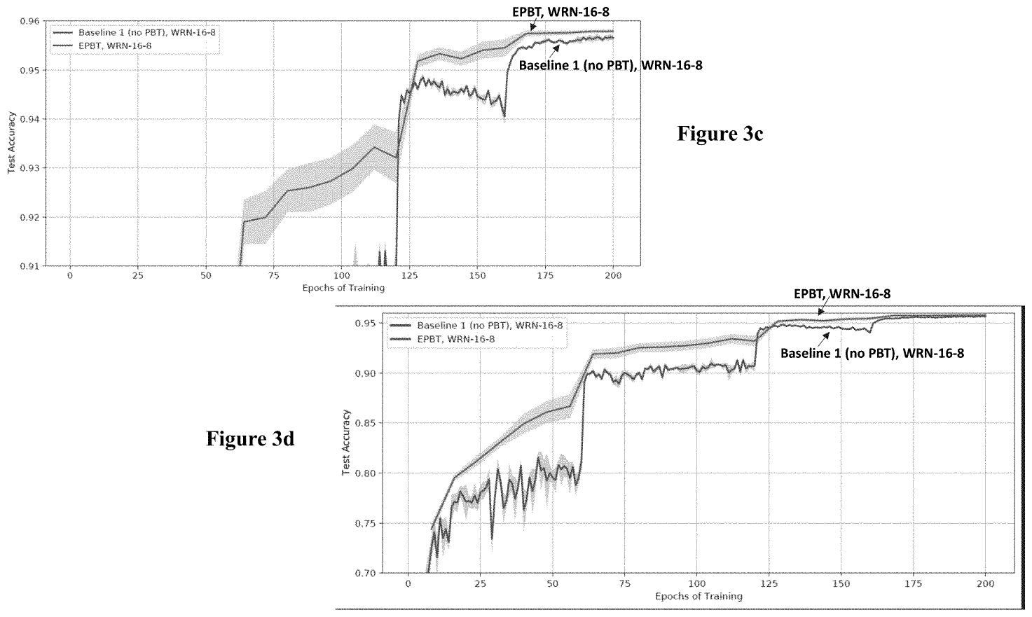

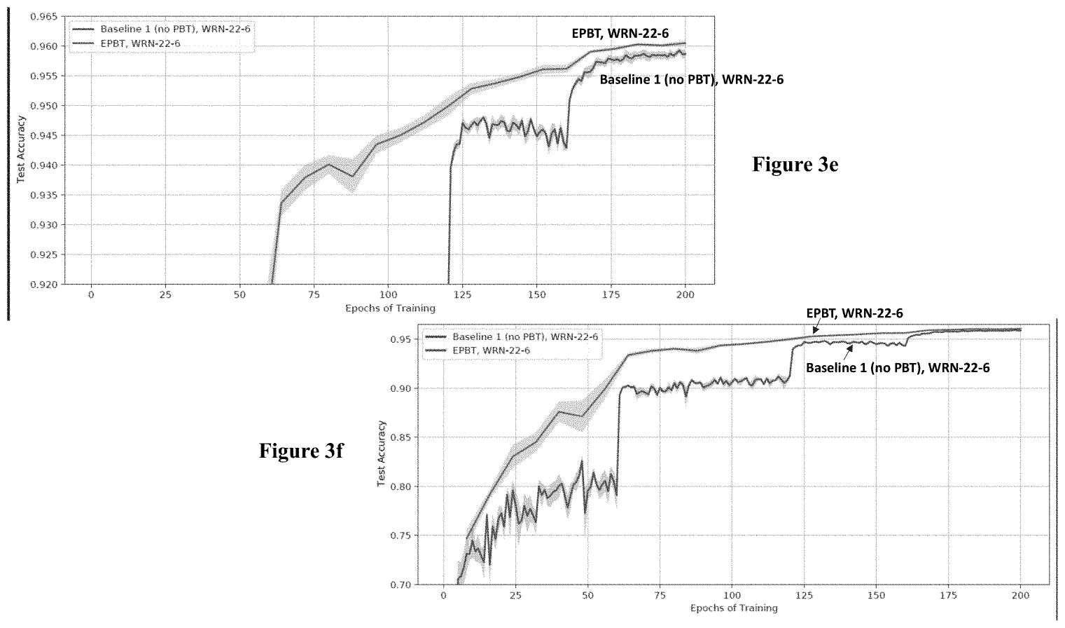

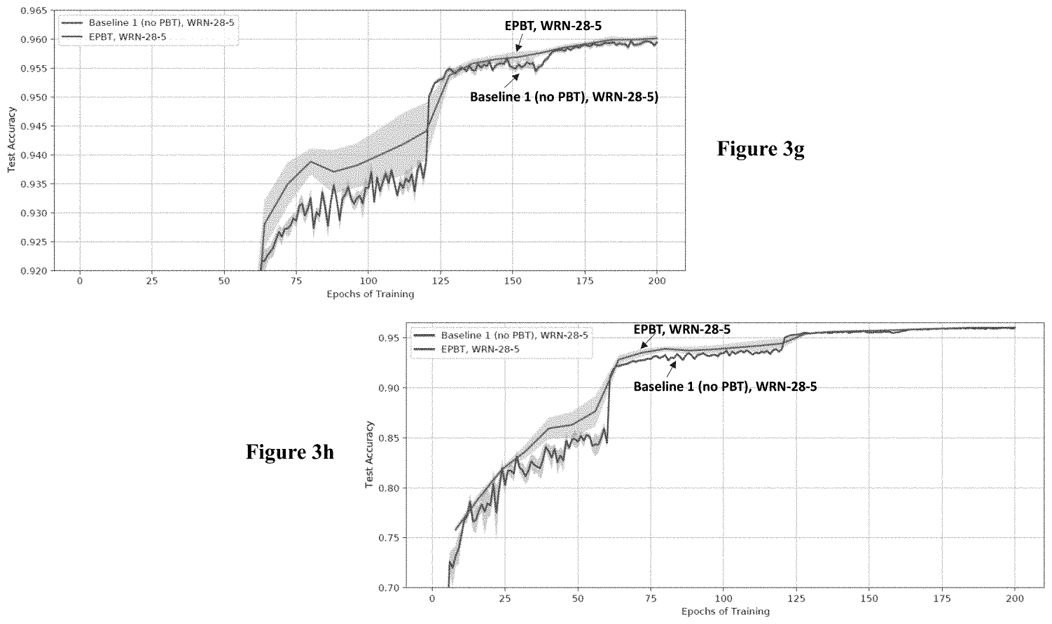

EPBT can also be scaled up to larger DNN architectures with more weights. In FIGS. 3a to 3h, Baseline 1 and EPBT are used to train four different wide residual networks with varying number of layers on CIFAR-10, but with similar number of parameters (11 million). The four architectures, in order of increasing depth, are: WRN-10-12 (FIGS. 3a, 3b), WRN- 16-8 (FIGS. 3c, 3d), WRN-22-6 (FIGS. 3e, 3f), and WRN-28-5 (FIGS. 3g, 3h). FIGS. 3a, 3c, 3e, 3g are zoomed in plots of 3b, 3d, 3f, 3h. EPBT is again able to achieve noticeable improvements over the baseline and achieve better test accuracy at a faster pace for all of the networks.

In next noteworthy embodiment, to demonstrate that loss function optimization scales with dataset size, EPBT is applied to SVHN, a larger image classification task. This dataset is composed of around 600,000 training images and 26,000 testing images. First, the dataset is normalized using known methods but no data augmentation is used during training. The baseline model is optimized with SGD on the full training set for a total of 40 epochs, with the learning rate decaying from 0.1 by a factor of 10 at 20 and 30 epochs respectively. EPBT is run for 40 generations, each with one epoch of training, and a validation set of 30,000 images is separated for evaluating individuals. Otherwise, the experiment setup is identical to the CIFAR-10 domain, as discussed above.

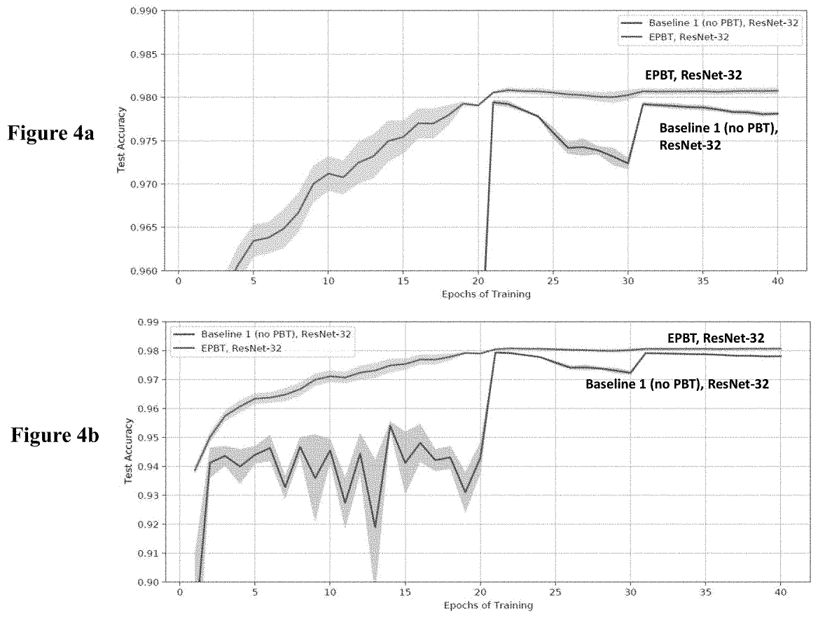

FIGS. 4a and 4b give a comparison of EPBT against Baseline 1 in the SVHN domain with ResNet-32. All results are averaged over five runs with error bars shown. FIG. 4a is a zoomed-in version of FIG. 4b. EPBT outperforms the baseline, which uses cross-entropy loss to train. Like in the earlier demonstration with CIFAR-10 and ResNet-32, both EPBT variants learn faster and converge to a high test accuracy at the end. Interestingly, while the baseline begins to overfit and drop in accuracy at the end of training, EPBT's regularization mechanisms allow it to avoid this effect and maintain performance.

An analysis of above obtained experimental results for performance and computational complexity of EPBT, as well as the loss functions and learning rate schedules that EPBT discovered is summarized in Table 1 below:

TABLE 1

| | CIFAR-10, | CIFAR-10, | CIFAR-10, | CIFAR-10, | CIFAR-10, | SVHN, |
|---|---|---|---|---|---|---|
| Algorithm | ResNet-32 | WRN-10-12 | WRN-16-8 | WRN-22-6 | WRN-28-5 | ResNet-32 |
| Baseline 1 | 92.42 (0.21) | 94.18 (0.09) | 95.66 (0.13) | 95.87 (0.18) | 95.95 (0.07) | 97.81 (0.04) |
| (no PBT) | | | | | | |
| Baseline 2 | 91.53 (0.56) | — | — | — | — | — |
| (PBT) | | | | | | |
| EPBT | 92.79 (0.15) | 94.38 (0.14) | 95.79 (0.08) | 96.05 (0.09) | 96.02 (0.12) | 98.08 (0.08) |

Table 1 provides mean and standard deviation (over five runs) of final test accuracies on the CIFAR-10 and SVHN datasets. EPBT achieves better results (%) compared to the baselines. The results show that EPBT achieves the best results for multiple datasets and model architectures. Another noticeable benefit provided by EPBT is the ability to train models to convergence significantly faster than non-population based methods, especially with a limited number of training epochs. This is because multiple models are simultaneously trained with EPBT, each with different loss functions. If progress is made in one of the models, its higher fitness leads to that model's loss function or weights being shared among the rest of the models, thus lifting their performance as well.

Table 2 as shown below details how many epochs of training are required for EPBT to surpass the fully trained performance of the baselines. The baselines were trained for 200 epochs in CIFAR-10 and 40 epochs in SVHN. As expected, EPBT outperforms the baselines on most architectures after training for 80% the total number of epochs. The results are remarkable considering that Baseline 1 is trained on the full training set, while EPBT is not. These experiments thus demonstrate the power of EPBT in not just training better models but doing it faster too. The experiments also suggest that EPBT's main components, i.e. the metalearning evolutionary loop, genetic operators, Novelty Selection and Pulsation, TaylorGLO parameterization, and PBD, serve as powerful metalearning and regularization tools when combined.

TABLE 2

| | CIFAR-10, | CIFAR-10, | CIFAR-10, | CIFAR-10, | CIFAR-10, | SVHN, |
|---|---|---|---|---|---|---|
| Algorithm | ResNet-32 | WRN-10-12 | WRN-16-8 | WRN-22-6 | WRN-28-5 | ResNet-32 |
| Baseline 1 | 168 | 168 | 168 | 176 | 184 | 21 |
| (no PBT) | | | | | | |
| Baseline 2 | 128 | — | — | — | — | — |
| (PBT) | | | | | | |

While each component has its own weaknesses, other components can help mitigate them. For example, TaylorGLO is useful for its regularizing effects, but the search space is large and potentially deceptive. However, Novelty Selection and Pulsation can help overcome this deception by maintaining population diversity. Similarly, PBD is a powerful general regularization tool that requires a good teacher model to work. Conveniently, such a model is provided by the elite individuals in EPBT's population.

When compared with simpler hyperparameter tuning methods that do not interleave training and optimization, EPBT is significantly more efficient. On the CIFAR-10 dataset, EPBT discovered 40 new loss functions during the first generation and an additional 20 loss functions every subsequent generation. EPBT is run for 25 generations and thus is able to explore up to 520 unique TaylorGLO parameterizations. This process is efficient given the size of the search space; if a grid search is performed at intervals of 1.0, a total of 218 (38 billion) unique loss function parameterizations will have to be evaluated.

Furthermore, the computational complexity of EPBT scales linearly with the population size and not with the number of loss functions explored. Loss function evaluation is efficient in EPBT because it is not necessary to retrain the model from scratch whenever a new loss function is discovered; the model's weights are copied over from an existing model with good performance. If each of the 520 discovered loss functions is used to fully train a model from random initialization, over 100,000 epochs of training would be required, much higher than the 8,000 epochs EPBT needed.

Because EPBT evaluates all the individuals in the population in parallel, the real-time complexity of each generation is not significantly higher than training a single model for the same number of epochs. Furthermore, the amount of time spent in Steps 1 and 2 to generate new individuals is negligible compared to Step 3, where model training occurs. In one specific embodiment, the EPBT based system and method run on a machine with eight NVIDIA V100 GPUs and utilize several GPU-days' worth of compute.

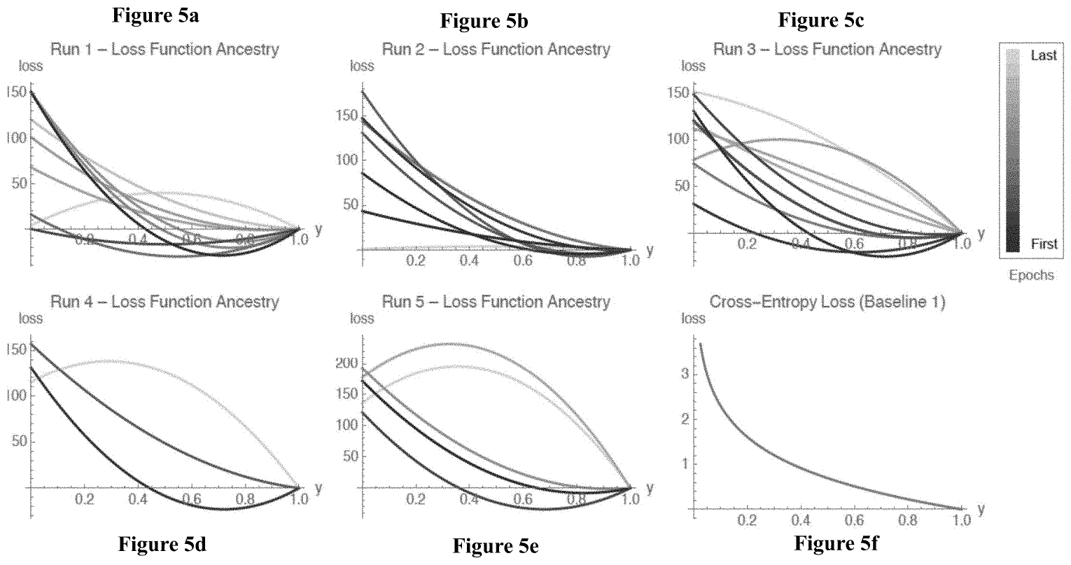

Regarding the loss function optimization, it is found that loss functions discovered by EPBT change significantly over the generations. To characterize how the loss functions adapt with increased training, the ancestries for the final top-performing functions across five separate runs of EPBT (CIFAR-10, ResNet-32) are shown in FIGS. 5a to 5e. The cross-entropy loss (as used in Baseline 1) is plotted for comparison as well in FIG. 5f. Ancestry is determined by tracing the sequence of individuals M_{0i . . . ni}, where M_{(g-1)i} is the parent whose D_{g-1)i} and h(h_{(g-1)i} are used to create M_{gi}. The sequence is simplified by removing any duplicate individuals that do not change between generations due to elitism, thus causing some runs to have shorter ancestries.

Because the loss functions are multidimensional, graphing them is not straightforward. However, for visualization purposes, the losses can be simplified into a 2D binary classification modality where y=1 represents a perfect prediction, and y=0 represents a completely incorrect prediction. This approach makes it clear that the loss generally decreases as the predicted labels become more accurate and closer to the ground-truth labels.

There is an interesting trend across all five runs: the loss functions optimized by EPBT are not all monotonically-decreasing. Instead, there are parabolic losses that have a minimum of around 0.7 and rises slightly as y approaches 1. Such concavity is likely a form of regularization that prevents the network from overfitting to the training data by penalizing low-entropy prediction distributions centered around y=1. Similar behavior is observed when training using GLO.

The plots also show that the loss functions change shape as training progresses. As the number of epochs increases, the slope near y=1 becomes increasingly positive, suggesting less regularization would occur. This result is consistent with recent research that suggests regularization is most important during a critical period early in the training process. If regularization is reduced or removed after this critical period, generalization sometimes may even improve. In EPBT, this principle is discovered and optimized without any prior knowledge as part of the metalearning process. EPBT thus provides an automatic way for exploring metaknowledge that could be difficult to come upon manually.

Since different stages of EPBT utilize different types of loss functions, it is possible that a single static loss might not be optimal for the entire training process. Furthermore, loss functions that change makes sense considering that the learning dynamics for some DNNs are non-stationary or unstable. For example, adaptive losses might improve the training of generative adversarial networks.

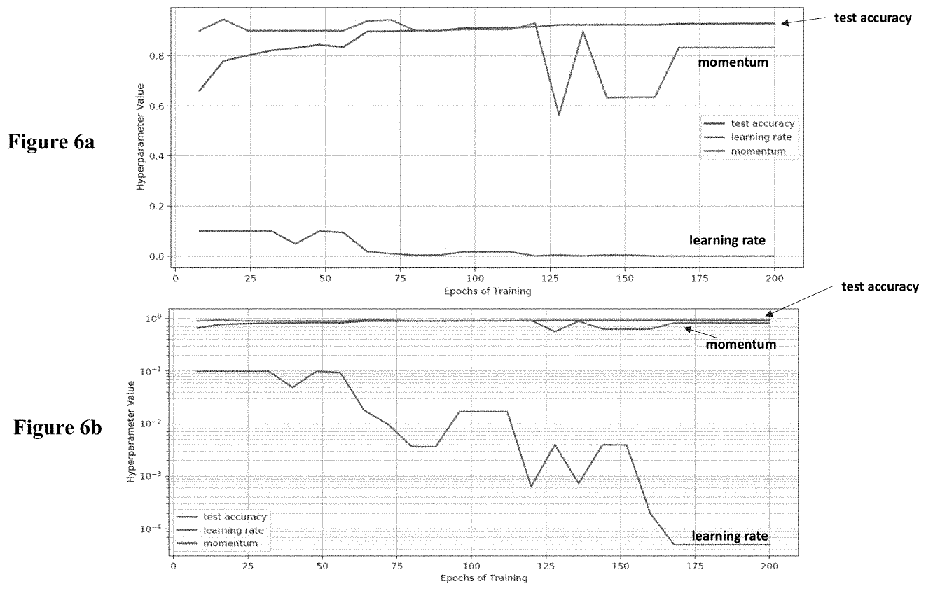

In addition to the TaylorGLO parameters, EPBT also optimized SGD hyperparameters such as learning rate schedule and momentum. FIGS. 6a and 6b show how these parameters of the best individual in the population changes over the course of an EPBT run (CIFAR-10, ResNet-32). FIG. 6b is a log-scale version of FIG. 6a. While momentum remains mostly the same with some occasional dips and bumps, there is a clear downward, decaying trend for learning rate. The discovered learning rate schedule shares several similarities with hand designed schedules: both use high learning rates early in training for rapid learning but lower learning rates later to fine tune the model weights. More interestingly, there appears to be several cycles in the EPBT optimized schedule where the learning rate repeatedly goes up and down. This might be due the beneficial effects of cyclic learning rates in helping SGD escape from saddle points in the loss landscape during training.

When viewed from the Evolutionary algorithm perspective, EPBT can be seen as a more complex variant of PBT. Mutation corresponds to the explore step and elitism corresponds to the exploit step in PBT. Besides Novelty Pulsation, EPBT improves upon PBT in two major ways. First, EPBT makes use of uniform Gaussian mutation (compared to the deterministic mutation in PBT) and uniform crossover. These biologically inspired heuristics allow PBT to scale better to higher dimensions. In particular, the crossover operator plays an important role in discovering good global solutions in large search spaces. Second, EPBT utilizes tournament selection, a heuristic that helps prevent premature convergence to a local optimum.

A system according to exemplary embodiments of the present invention can be provided which includes one or more processing arrangements such as may be found, e.g., in a personal computer or computer workstation. Such system can further include a set of instructions which are capable of configuring the processing arrangement to perform the exemplary methods described herein for regularizing deep neural network (DNN). The instructions can be provided on a computer-accessible medium such as a storage arrangement. The storage arrangement can include, e.g., a hard drive, a CD-ROM or DVD-ROM, a tape or floppy disk, a flash drive, or any other solid-state memory storage medium.

To conclude, the present system and method discloses EPBT based evolutionary algorithm for regularization metalearning. EPBT first improves upon PBT by introducing more advanced genetic operators. It then focuses it on regularization by evolving TaylorGLO loss functions. The deceptive interactions of weight and loss adaptation require more diversity, which is achieved through Novelty Pulsation, and more careful avoidance of overfitting, which is achieved through Population-Based Distillation. On the CIFAR-10 and SVHN image classification benchmarks with several ResNet and Wide Resnet architectures, EPBT achieved faster and better model training. An analysis of the optimized loss functions suggests that these advantages stem from discovering strong regularization automatically. Furthermore, an adaptive loss function schedule naturally emerges as a likely key to achieving such performance. EPBT thus forms a practical method for regularization metalearning in deep networks.

The foregoing description is a specific embodiment of the present disclosure. It should be appreciated that this embodiment is described for purpose of illustration only, and that those skilled in the art may practice numerous alterations and modifications without departing from the spirit and scope of the invention. It is intended that all such modifications and alterations be included insofar as they come within the scope of the invention as claimed or the equivalents thereof.

1. A method for regularizing deep neural network (DNN), comprising:
selecting a first set of individuals from an initial population of a generation, wherein the individuals have a corresponding DNN model, hyperparameters and a fitness value associated therewith;
generating a second set of individuals from the first set of individuals, wherein the second set consists of one or more new individuals having updated hyperparameters associated therewith; and
evaluating the one or more new individuals by training the DNN model to obtain a pool of evaluated individuals with an updated DNN model, the updated hyperparameters and an updated fitness value.

2. The method, as claimed in claim 1, wherein the selection of the first set of population is based on a combination of fitness value, novelty selection or a combination thereof.

3. The method, as claimed in claim 1, wherein the DNN model comprises of model weight and a model architecture.

4. The method, as claimed in claim 1, wherein the hyperparameters and the updated hyperparameters have a corresponding loss function associated therewith.

5. The method, as claimed in claim 4, wherein the second set of individuals consisting of the one or more new individuals is generated using genetic operators for hyperparameter and associated loss function optimization.

6. The method, as claimed in claim 1, wherein the new individuals of the second set of individuals inherit the DNN model of that of the initial population.

7. The method, as claimed in claim 1, wherein the first set of individuals is selected from the initial population using a tournament selection operator.

8. The method, as claimed in claim 1, wherein for each individual of the first set of individuals:
applying a mutation operator to each variable in the hyperparameters of the individual; and
applying a crossover operator by randomly swapping each variable in the hyperparameters of the individual with same variable from hyperparameters of other individual of the generation to create the updated hyperparameters for the one or more new individuals of the second set of population.

9. The method, as claimed in claim 1, further comprising iteratively performing steps of claim 1 for one or more generations until fitness of an optimum individual converges.

10. The method, as claimed in claim 4, wherein the hyperparameters and the associated loss functions are evolved and optimized by representing a parameterized loss function using a third order TaylorGLO representation.

11. The method, as claimed in claim 1, wherein population-based distillation (PBD) is utilized to prevent overfitting-based identification of best model output in the population and computation of standard loss for an individual DNN model.

12. The method, as claimed in claim 11, wherein the population-based distillation (PBD) approach is configured to share weights and evolvable hyperparameters to train the individual DNN model in parallel.

13. The method, as claimed in claim 12, further comprising evolving a learning rate hyperparameter with a tunable scaling and decay factor.

14. The method, as claimed in claim 1, wherein weights of the DNN model of the initial population are randomly initialized.

15. The method as claimed in claim 1, wherein each variable in the hyperparameters of the initial population is randomly initialized.

16. The method as claimed in claim 1, wherein fitness value of the initial population is set to zero.

17. A system for regularizing deep neural network (DNN), comprising:
a processing arrangement; and
a computer-readable medium which includes thereon a set of instructions, wherein the set of instructions is configured to effectuate the processing arrangement to perform procedures comprising:
selecting a first set of individuals from an initial population of a generation, wherein the individuals have a corresponding DNN model, hyperparameters and a fitness value associated therewith;
generating a second set of individuals from the first set of individuals, wherein the second set consists of one or more new individuals having updated hyperparameters associated therewith; and
evaluating the one or more new individuals by training the DNN model to obtain a pool of evaluated individuals with an updated DNN model, the updated hyperparameters and an updated fitness value.

18. The system, as claimed in claim 17, wherein the selection of the first set of population is based on a combination of fitness value, novelty selection or a combination thereof.

19. The system, as claimed in claim 17, wherein the DNN model comprises of model weight and a model architecture.

20. The system, as claimed in claim 17, wherein the hyperparameters and the updated hyperparameters have a corresponding loss function associated therewith.

21. The system, as claimed in claim 20, wherein the second set of individuals consisting of the one or more new individuals is generated using genetic operators for hyperparameter and associated loss function optimization.

22. The system, as claimed in claim 17, wherein the new individuals of the second set of individuals inherit the DNN model of that of the initial population.

23. The system, as claimed in claim 17, wherein the first set of individuals is selected from the initial population using a tournament selection operator.

24. The system, as claimed in claim 17, wherein for each individual of the first set of individuals:
applying a mutation operator to each variable in the hyperparameters of the individual; and
applying a crossover operator by randomly swapping each variable in the hyperparameters of the individual with same variable from hyperparameters of other individual of the generation to create the updated hyperparameters for the one or more new individuals of the second set of population.

25. The system, as claimed in claim 17, further comprising iteratively performing steps of claim 1 for one or more generations until fitness of an optimum individual converges.

26. The system, as claimed in claim 20, wherein the hyperparameters and the associated loss functions are evolved and optimized by representing a parameterized loss function using a third order TaylorGLO representation.

27. The system, as claimed in claim 20, wherein population-based distillation (PBD) is utilized to prevent overfitting-based identification of best model output in the population and computation of standard loss for an individual DNN model.

28. The system, as claimed in claim 27, wherein the population-based distillation (PBD) approach is configured to share weights and evolvable hyperparameters to train the individual DNN model in parallel.

29. The system, as claimed in claim 28, further comprising evolving a learning rate hyperparameter with a tunable scaling and decay factor.

30. The system, as claimed in claim 17, wherein weights of the DNN model of the initial population are randomly initialized.

31. The system, as claimed in claim 17, wherein each variable in the hyperparameters of the initial population is randomly initialized.

32. The system, as claimed in claim 17, wherein fitness value of the initial population is set to zero.
